(19) United States
(12) Patent Application Publication
(10) Pub. No.: US 2008/0174795 A1
(43) Pub. Date: Jul. 24, 2008

(54) Reshaping an image to thin or fatten a face

(75) Inventor: Ana Cristina Andres Del Valle, Antibes (FR)

Correspondence Address: BANNER & WITCOFF, LTD.;ATTORNEYS FOR CLIENT NO. 005222, 10 S. WACKER DRIVE, 30TH FLOOR, CHICAGO, IL, 60606, US

(73) Assignee: Accenture Global Services GMBH, Schaffnausen (CH)

(21) Appl. No.: 11/625,937

(22) Filed: Jan. 23, 2007

(51) Int. Cl. H04N 1/60

(52) U.S. Cl. 358/1.9

(57) ABSTRACT

Apparatuses, computer media, and methods for altering an image of a person' face. Points on a two-dimensional image of a face and a neck of the person are located. A superimposed mesh is generated from the points. A subset of the points is relocated, forming a transformed mesh. Consequently, the face is reshaped from the transformed mesh to obtain a desired degree of fattening or thinning, and a reshaped image is rendered. A subset of points on the face is relocated by applying a deformation vector to each point of the subset of points. The deformation vector is determined from a product of factors. The factors include a weight value factor, a scale factor, a deformation factor, and a direction vector. The weight factor may be determined from a desired amount of fattening or thinning.

### FIELD OF THE INVENTION

This invention relates to altering the image of a person's face. More particularly, the invention applies a desired degree of fattening or thinning to the face and neck.

### BACKGROUND OF THE INVENTION

Excessive body weight is a major cause of many medical illnesses. With today's life style, people are typically exercising less and eating more. Needless to say, this life style is not conducive to good health. For example, it is acknowledged that type-2 diabetes is trending to epidemic proportions. Obesity appears to be a major contributor to this trend.

On the other hand, a smaller proportion of the population experiences from being underweight. However, the effects of being underweight may be even more divesting to the person than to another person being overweight. In numerous related cases, people eat too little as a result of a self-perception problem. Anorexia is one affliction that is often associated with being grossly underweight.

While being overweight or underweight may have organic causes, often such afflictions are the result of psychological issues. If one can objectively view the effect of being underweight or underweight, one may be motivated to change one's life style, e.g., eating in a healthier fashion or exercising more. Viewing a predicted image of one's body if one continues one's current life style may motivate the person to live in a healthier manner.

### BRIEF SUMMARY OF THE INVENTION

Embodiments of invention provide apparatuses, computer media, and methods for altering an image of a person' face.

With one aspect of the invention, a plurality of points on a two-dimensional image of a face and a neck of the person are located. A superimposed mesh is generated from the points. A subset of the points is relocated, forming a transformed mesh. Consequently, the face is reshaped from the transformed mesh to obtain a desired degree of fattening or thinning, and a reshaped image is rendered.

With another aspect of the invention, the neck in an image is altered by relocating selected points on the neck.

With another aspect of the invention, a subset of points on the face is relocated by applying a deformation vector to each point of the subset. A transformed mesh is then generated.

With another aspect of the invention, a deformation vector is determined from a product of factors. The factors include a weight value factor, a scale factor, a deformation factor, and a direction vector. The weight factor may be determined from a desired amount of fattening or thinning.

### BRIEF DESCRIPTION OF THE DRAWINGS

The present invention is illustrated by way of example and not limited in the accompanying figures in which like reference numerals indicate similar elements and in which:

FIG. 1 shows a mesh that is superimposed in a face image in accordance with an embodiment of the image.

FIG. 2 shows a set of points for altering a face image in accordance with an embodiment of the invention.

FIG. 3 shows controlling points for face alteration in accordance with an embodiment of the invention.

FIG. 4 shows visual results for altering a face image in accordance with an embodiment of the invention.

FIG. 5 shows additional visual results for altering a face image in accordance with an embodiment of the invention.

FIG. 6 shows additional visual results for altering a face image in accordance with an embodiment of the invention.

FIG. 7 shows additional visual results for altering a face image in accordance with an embodiment of the invention.

FIG. 8 shows a flow diagram for altering a face image in accordance with an embodiment of the invention.

FIG. 9 shows an architecture of a computer system used in altering a face image in accordance with an embodiment of the invention.

### DETAILED DESCRIPTION OF THE INVENTION

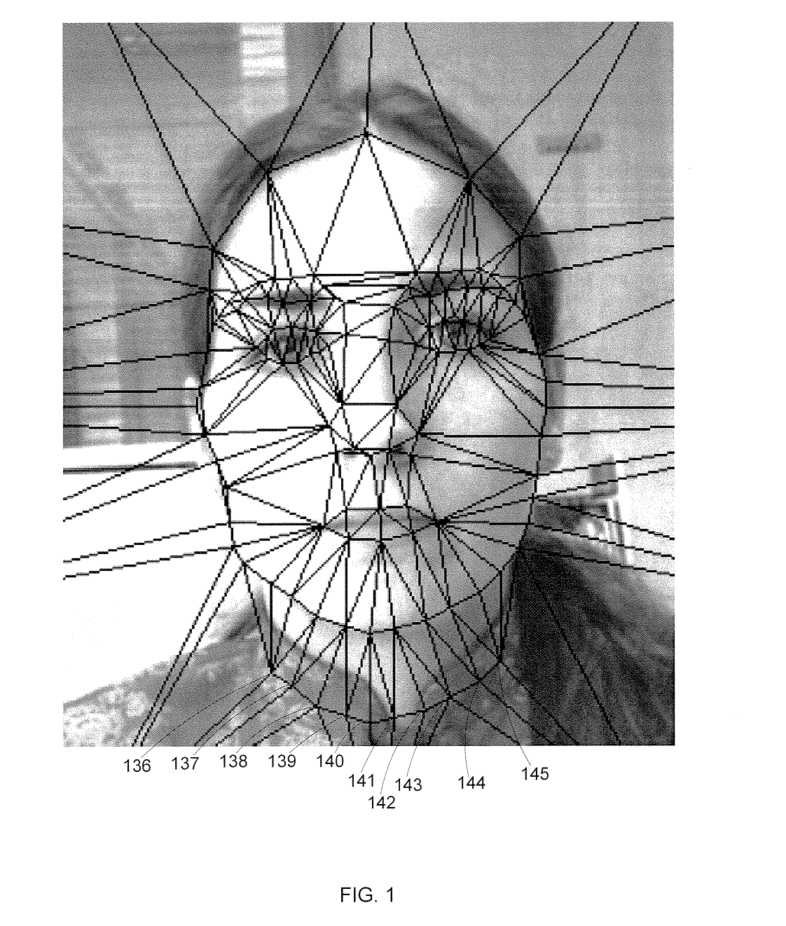

FIG. 1 shows a mesh that is superimposed in a face image in accordance with an embodiment of the image. As will be discussed, an algorithm fattens or thins the face image in accordance with an embodiment of the invention. Points along the face, neck, and image boundary are determined in order to form the mesh. As will be further discussed, the algorithm alters the facial contour and then reshapes the area around the neck. (Points 136-145 will be discussed in a later discussion.) The altered image is rendered by using the points as vertices of the mesh.

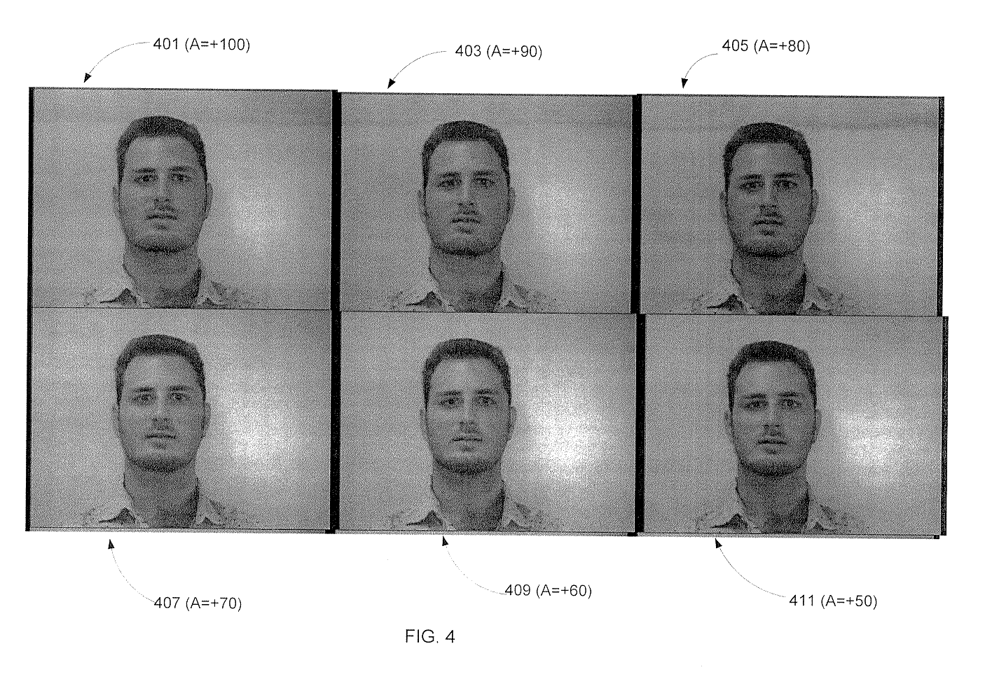

This mesh is associated to its corresponding texture from the picture where the alteration is taking place. The corners and four points along each side of the picture (as shown in FIG. 1) are also considered as part of the mesh. Computer graphics software API (Application Programming Interface) is used to render the altered image (e.g., as shown in FIGS. 4-7). OpenGL API is an example of computer graphics software that may be used to render the altered image.

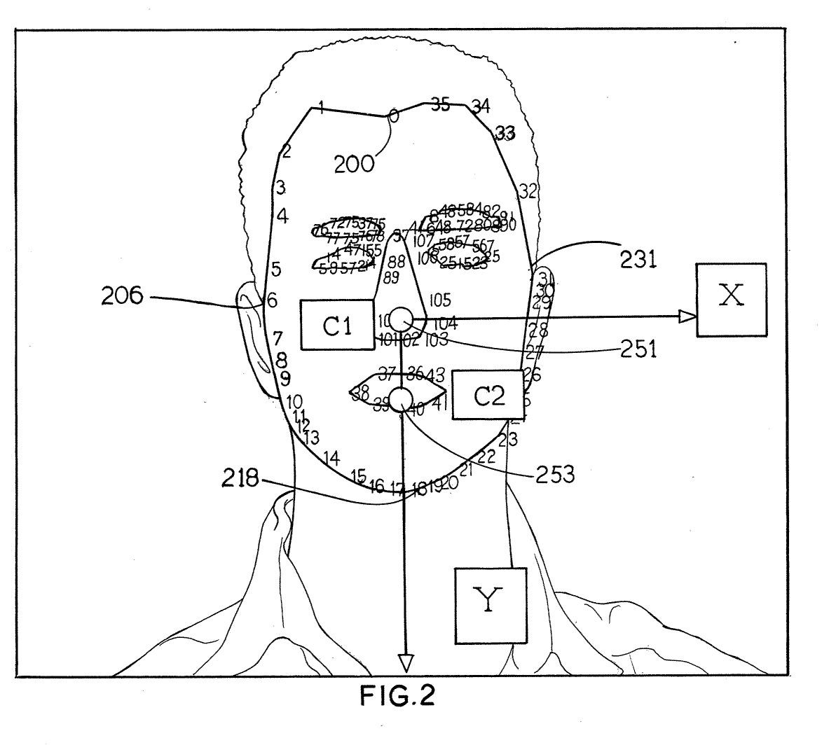

FIG. 2 shows a set of points (including points 200, 206, 218, and 231 which will be discussed in further detail) for altering a face image in accordance with an embodiment of the invention. (Please note that FIG. 2 shows a plurality of points, which correspond to the vertices of the mesh.) Points 200, 206, 218, and 231 are only some of the plurality of points. An embodiment of the invention uses the search function of a software technique called Active Appearance Model (AAM), which utilizes a trained model. (Information about AAM is available at http://www2.imm.dtu.dk/˜aam and has been utilized by other researchers.) However, points 200, 206, 218, and 231 may be determined with other approaches, e.g., a manual process that is performed by medical practitioner manually entering the points. With an embodiment of the invention, the trained model is an AMF file, which is obtained from the training process. For the training the AAM, a set of images with faces is needed. These images may belong to the same person or different people. Training is typically dependent on the desired degree of accuracy and the degree of universality of the population that is covered by the model. With an exemplary embodiment, one typically processes at least five images with the algorithm that is used. During the training process, the mesh is manually deformed on each image. Once all images are processed, the AAM algorithms are executed over the set of points and images, and a global texture/shape model is generated and stored in an AMF file. The AMF file permits an automatic search in future images not belonging to the training set. With an exemplary embodiment, one uses the AAM API to generate Appearance Model Files (AMF). Embodiments of the invention also support inputting the plurality of points through an input device as entered by a user. A mesh is superimposed on the image at points (e.g., the set of points shown in FIG. 2) as determined by the trained process.

FIG. 2 also shows the orientation of the x and y coordinates of the points as shown in FIGS. 1-3.

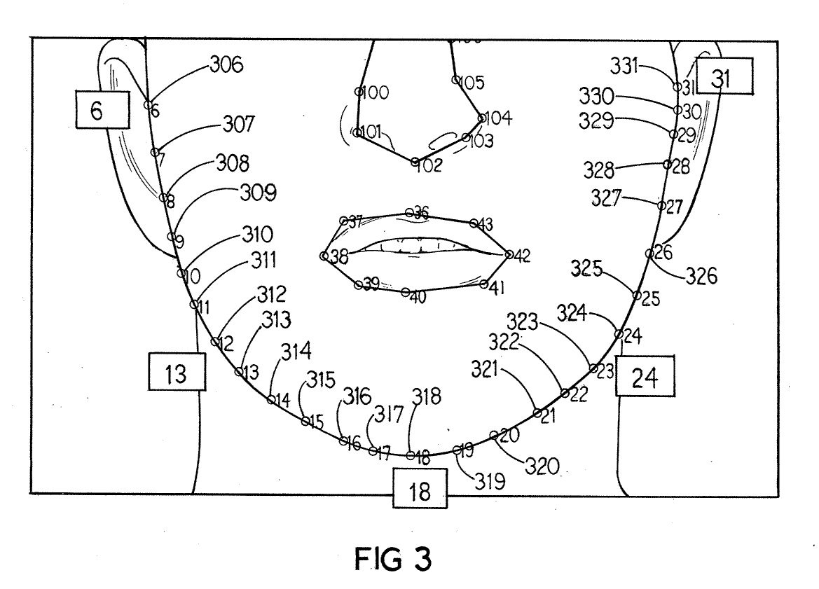

FIG. 3 shows controlling points 306-331 for face alteration in accordance with an embodiment of the invention. (Points 306, 318, and 331 correspond to points 206, 218, and 231 respectively as shown in FIG. 2.) Points 306-331, which correspond to points around the cheeks and chin of the face, are relocated (transformed) for fattening or thinning a face image to a desired degree. With an embodiment of the invention, only a proper subset (points 306-331) of the plurality of points (as shown in FIG. 2) are relocated. (With a proper subset, only some, and not all, of the plurality points are included.)

In the following discussion that describes the determination of the deformation vectors for reshaping the face image, index i=6 to index i=31 correspond to points 306 to points 331, respectively. The determined deformation vectors are added to points 306 to points 331 to re-position the point, forming a transformed mesh. A reshaped image is consequently rendered using the transformed mesh.

In accordance with embodiments of the invention, deformation vector correspond to a product of four elements (factors):

\vec{v}_{d}=\vec{u}·s·w·A (EQ. 1)

where A is the weight value factor, s is the scale factor, w is the deformation factor, and \vec{u} is the direction vector. In accordance with an embodiment of the invention:
Weight value factor [A]: It determines the strength of the thinning and fattening that we wan to apply.

A>0 fattening (EQ. 2A)

A<0 thinning (EQ. 2B)

A=0 no change (EQ. 2C)
Scale factor [s]. It is the value of the width of the face divided by B. One uses this factor to make this vector calculation independent of the size of the head we are working with. The value of B will influence how the refined is the scale of the deformation. It will give the units to the weight value that will be applied externally.

$$s = \frac{\vert {x}_{31} - {x}_{6} \vert}{B} \qquad ( EQ . 3 )$$

Deformation factor [w]. It is calculated differently for different parts of cheeks and chin. One uses a different equation depending on which part of the face one is processing:

$$\begin{matrix}i ∈ [ 6 \text{-} 13 ] {w}_{i} = \frac{2}{3} \frac{1}{\vert {x}_{6} - {x}_{13} \vert} \vert {x}_{i} - {x}_{C 1} \vert + \frac{1}{3} & ( EQ . 4 A ) \\ i ∈ [ 14 \text{-} 18 ] {w}_{i} = - \frac{1}{{\vert {x}_{13} - {x}_{18} \vert}^{2}} {\vert {x}_{i} - {x}_{C 1} \vert}^{2} + 1 & ( EQ . 4 B ) \\ i ∈ [ 19 \text{-} 23 ] {w}_{i} = - \frac{1}{{\vert {x}_{18} - {x}_{24} \vert}^{2}} {\vert {x}_{i} - {x}_{C 1} \vert}^{2} + 1 & ( EQ . 4 C ) \\ i ∈ [ 24 \text{-} 31 ] {w}_{i} = \frac{2}{3} \frac{1}{\vert {x}_{24} - {x}_{31} \vert} \vert {x}_{i} - {x}_{C 2} \vert + \frac{1}{3} & ( EQ . 4 D )\end{matrix}$$

Direction vector [\vec{u}]: It indicates the sense of the deformation. One calculates the direction vector it the ratio between: the difference (for each coordinate) between the center and our point, and the absolute distance between this center and our point. One uses two different centers in this process: center C2 (point 253 as shown in FIG. 2) for the points belonging to the jaw and center C1 (point 253 as shown in FIG. 2) for the points belonging to the cheeks.

$$\begin{matrix}i ∈ [ 6 \text{-} 13 ] \& [ 24 \text{-} 31 ] {\vec{u}}_{i} = \frac{{x}_{i} - {x}_{C 1}}{\vert {x}_{i} - {x}_{C 1} \vert} & ( EQ . 5 A ) \\ i ∈ [ 14 \text{-} 23 ] {\vec{u}}_{i} = \frac{{x}_{i} - {x}_{C 2}}{\vert {x}_{i} - {x}_{C 2} \vert} & ( EQ . 5 B )\end{matrix}$$

Neck point-coordinates xᵢ are based on the lower part of the face, where

$$\begin{matrix}i ∈ [ 36 \text{-} 45 ] j ∈ [ 14 \text{-} 23 ] {x}_{i} = ( {x}_{j} , {y}_{i} + neck\_height ) & ( EQ . 6 ) \\ neck\_height = \frac{{y}_{18} - {y}_{0}}{6} & ( EQ . 7 )\end{matrix}$$

where y₁₈ and y₀ are the y-coordinates of points 218 and 200, respectively, as shown in FIG. 2. Referring back to FIG. 1, index i=36 to i=45 correspond to points 136 to 145, respectively. Index j=14 to j=23 correspond to points 314 to 323, respectively, (as shown in FIG. 3) on the lower part of the face, from which points 136 to 145 on the neck are determined. (In an embodiment of the invention, points 136 to 145 are determined from points 314 to 323 before points 314 to 323 are relocated in accordance with EQs. 1-5.)

The deformation vector (\vec{v}_{d}_{_{—}}_{neck}) applied at points 136 to 145 has two components:

$$\begin{matrix}{\vec{v}}_{d\_neck} = ( 0 , {y}_{d\_neck} ) & ( EQ . 8 ) \\ when {x}_{i} < {x}_{41} {y}_{{d\_neck}_{t}} = - \frac{{( {x}_{i} - {x}_{18} )}^{2}}{10 \cdot {( \frac{{x}_{24} - {x}_{13}}{2} )}^{2}} & ( EQ . 9 A ) \\ when {x}_{i} \geq {x}_{41} {y}_{{d\_neck}_{t}} = \frac{{( {x}_{i} - {x}_{18} )}^{2}}{10 \cdot {( \frac{{x}_{24} - {x}_{13}}{2} )}^{2}} & ( EQ . 9 B )\end{matrix}$$

The Appendix provides exemplary software code that implements the above algorithm.

FIG. 4 shows visual results for altering a face image in accordance with an embodiment of the invention. Images 401 to 411 correspond to A=+100 to A=+50, respectively, which correspond to decreasing degrees of fattening.

With an embodiment of the invention, A=+100 corresponds to a maximum degree of fattening and A=−100 corresponds to a maximum degree of thinning. The value of A is selected to provide the desired degree of fattening or thinning. For example, if a patient were afflicted anorexia, the value of A would have a negative value that would depend on the degree of affliction and on the medical history and body type of the patient. As another example, a patient may be over-eating or may have an unhealthy diet with many empty calories. In such a case, A would have a positive value. A medical practitioner may be able to gauge the value of A based on experience. However, embodiments of invention may support an automated implementation for determining the value of A. For example, an expert system may incorporate knowledge based on information provided by experienced medical practitioners.

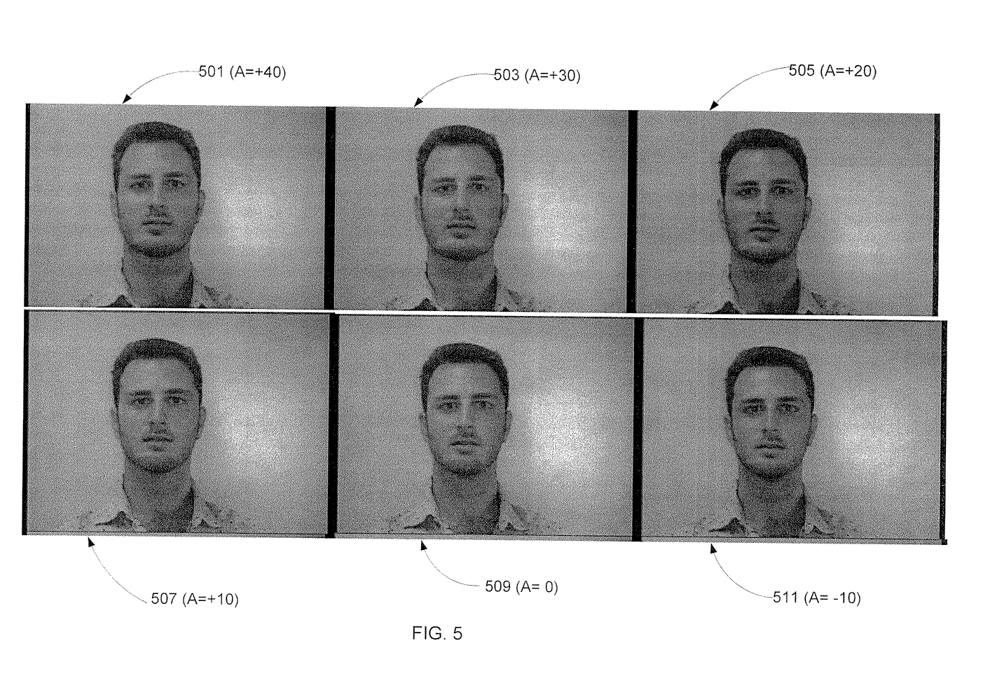

FIG. 5 shows additional visual results for altering a face image in accordance with an embodiment of the invention. Images 501-511, corresponding to A=+40 to A=−10, show the continued reduced sequencing of the fattening. When A=0 (image 509), the face is shown as it really appears. With A=−10 (image 511), the face is shows thinning. As A becomes more negative, the effects of thinning is increased.

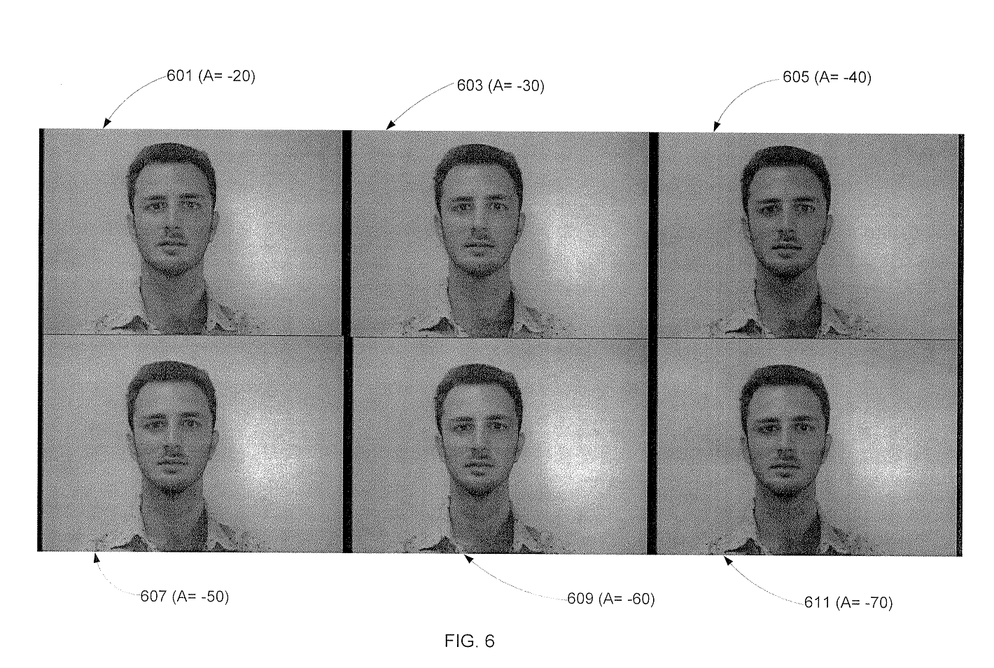

FIG. 6 shows additional visual results for altering a face image in accordance with an embodiment of the invention. Images 601-611 continue the sequencing of images with increased thinning (i.e., A becoming more negative).

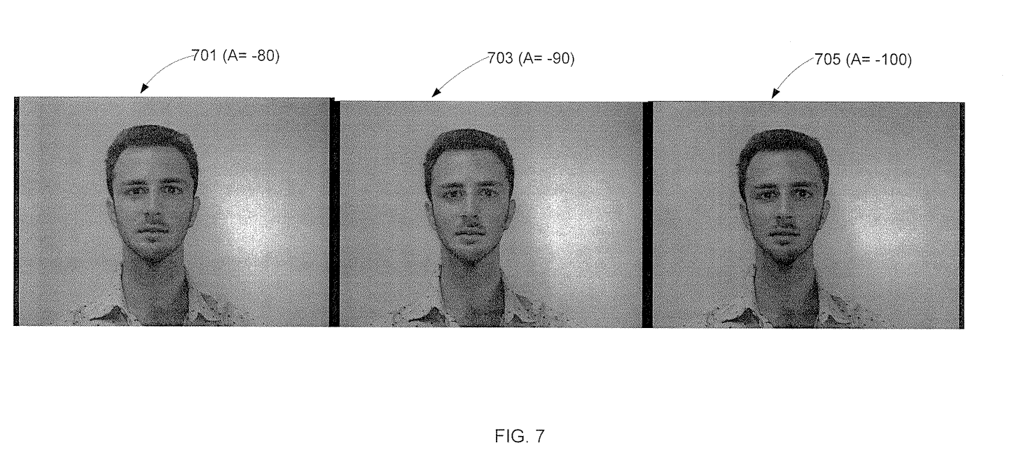

FIG. 7 shows additional visual results for altering a face image in accordance with an embodiment of the invention. Images 701-705 complete the sequencing of the images, in which the degree of thinning increases.

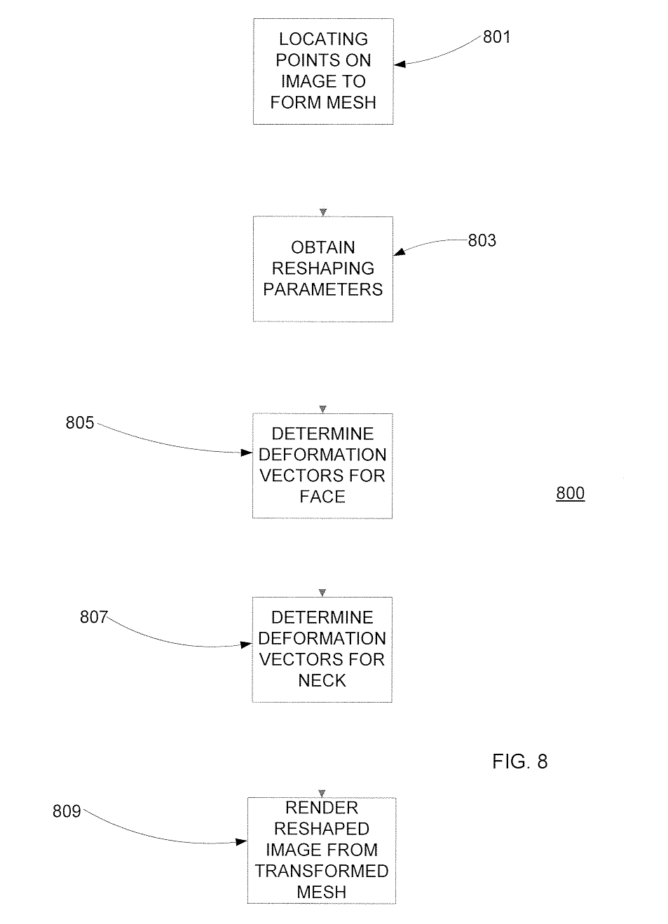

FIG. 8 shows flow diagram 800 for altering a face image in accordance with an embodiment of the invention. In step 801, points are located on the image of the face and neck in order form a mesh. Points may be determined by a trained process or may be entered through an input device by a medical practitioner. In step 803, reshaping parameters (e.g., a weight value factor A) are obtained. The reshaping factors may be entered by the medical practitioner or may be determined by a process (e.g. an expert system) from information about the person associated with the face image.

In step 805 deformation vectors are determined and applied to points (e.g. points 306-331 as shown in FIG. 3) on the face. For example, as discussed above, EQs. 1-5. are used to determine the relocated points. In step 807 deformation vectors are determined (e.g., using EQs. 6-9) and applied to points (e.g., points 136-145 as shown in FIG. 1) on the neck. A transformed mesh is generated from which a reshaped image is rendered using computer graphics software in step 809.

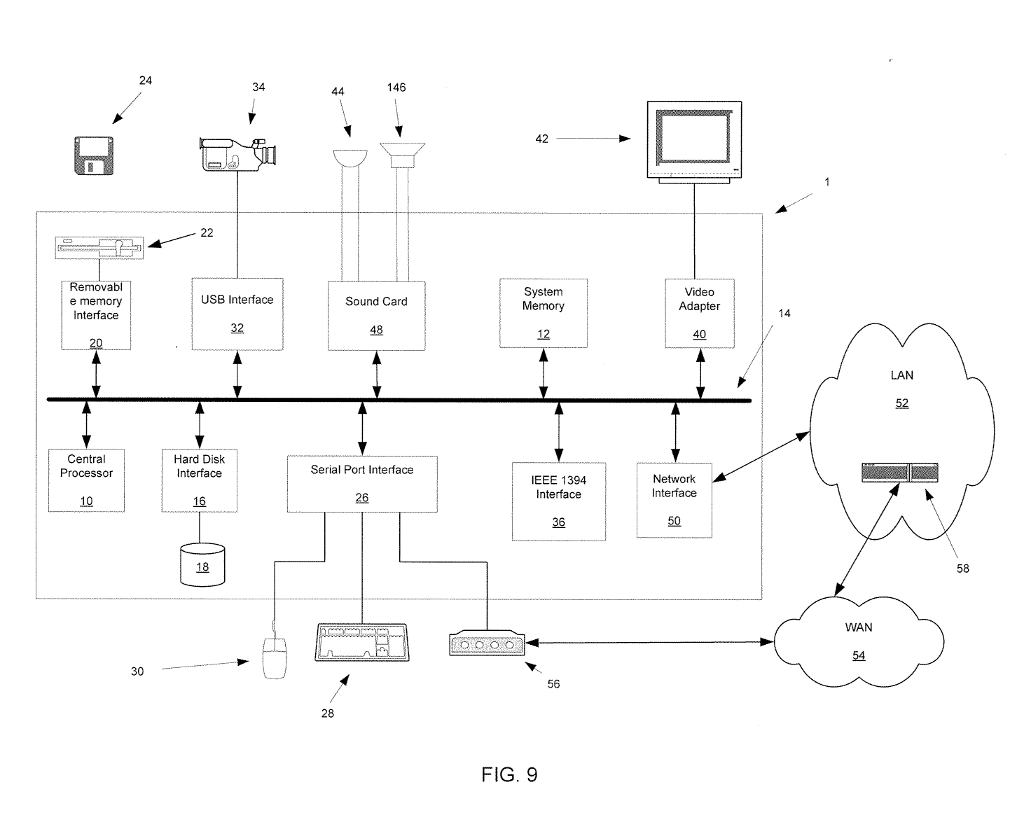

FIG. 9 shows computer system 1 that supports an alteration of a face image in accordance with an embodiment of the invention. Elements of the present invention may be implemented with computer systems, such as the system 1. Computer system 1 includes a central processor 10, a system memory 12 and a system bus 14 that couples various system components including the system memory 12 to the central processor unit 10. System bus 14 may be any of several types of bus structures including a memory bus or memory controller, a peripheral bus, and a local bus using any of a variety of bus architectures. The structure of system memory 12 is well known to those skilled in the art and may include a basic input/output system (BIOS) stored in a read only memory (ROM) and one or more program modules such as operating systems, application programs and program data stored in random access memory (RAM).

Computer 1 may also include a variety of interface units and drives for reading and writing data. In particular, computer 1 includes a hard disk interface 16 and a removable memory interface 20 respectively coupling a hard disk drive 18 and a removable memory drive 22 to system bus 14. Examples of removable memory drives include magnetic disk drives and optical disk drives. The drives and their associated computer-readable media, such as a floppy disk 24 provide nonvolatile storage of computer readable instructions, data structures, program modules and other data for computer 1. A single hard disk drive 18 and a single removable memory drive 22 are shown for illustration purposes only and with the understanding that computer 1 may include several of such drives. Furthermore, computer 1 may include drives for interfacing with other types of computer readable media.

A user can interact with computer 1 with a variety of input devices. FIG. 7 shows a serial port interface 26 coupling a keyboard 28 and a pointing device 30 to system bus 14. Pointing device 28 may be implemented with a mouse, track ball, pen device, or similar device. Of course one or more other input devices (not shown) such as a joystick, game pad, satellite dish, scanner, touch sensitive screen or the like may be connected to computer 1.

Computer 1 may include additional interfaces for connecting devices to system bus 14. FIG. 7 shows a universal serial bus (USB) interface 32 coupling a video or digital camera 34 to system bus 14. An IEEE 1394 interface 36 may be used to couple additional devices to computer 1. Furthermore, interface 36 may configured to operate with particular manufacture interfaces such as FireWire developed by Apple Computer and i.Link developed by Sony. Input devices may also be coupled to system bus 114 through a parallel port, a game port, a PCI board or any other interface used to couple and input device to a computer.

Computer 1 also includes a video adapter 40 coupling a display device 42 to system bus 14. Display device 42 may include a cathode ray tube (CRT), liquid crystal display (LCD), field emission display (FED), plasma display or any other device that produces an image that is viewable by the user. Additional output devices, such as a printing device (not shown), may be connected to computer 1.

Sound can be recorded and reproduced with a microphone 44 and a speaker 66. A sound card 48 may be used to couple microphone 44 and speaker 46 to system bus 14. One skilled in the art will appreciate that the device connections shown in FIG. 7 are for illustration purposes only and that several of the peripheral devices could be coupled to system bus 14 via alternative interfaces. For example, video camera 34 could be connected to IEEE 1394 interface 36 and pointing device 30 could be connected to USB interface 32.

Computer 1 can operate in a networked environment using logical connections to one or more remote computers or other devices, such as a server, a router, a network personal computer, a peer device or other common network node, a wireless telephone or wireless personal digital assistant. Computer 1 includes a network interface 50 that couples system bus 14 to a local area network (LAN) 52. Networking environments are commonplace in offices, enterprise-wide computer networks and home computer systems.

A wide area network (WAN) 54, such as the Internet, can also be accessed by computer 1. FIG. 7 shows a modem unit 56 connected to serial port interface 26 and to WAN 54. Modem unit 56 may be located within or external to computer 1 and may be any type of conventional modem such as a cable modem or a satellite modem. LAN 52 may also be used to connect to WAN 54. FIG. 7 shows a router 58 that may connect LAN 52 to WAN 54 in a conventional manner.

It will be appreciated that the network connections shown are exemplary and other ways of establishing a communications link between the computers can be used. The existence of any of various well-known protocols, such as TCP/IP, Frame Relay, Ethernet, FTP, HTTP and the like, is presumed, and computer 1 can be operated in a client-server configuration to permit a user to retrieve web pages from a web-based server. Furthermore, any of various conventional web browsers can be used to display and manipulate data on web pages.

The operation of computer 1 can be controlled by a variety of different program modules. Examples of program modules are routines, programs, objects, components, and data structures that perform particular tasks or implement particular abstract data types. The present invention may also be practiced with other computer system configurations, including hand-held devices, multiprocessor systems, microprocessor-based or programmable consumer electronics, network PCS, minicomputers, mainframe computers, personal digital assistants and the like. Furthermore, the invention may also be practiced in distributed computing environments where tasks are performed by remote processing devices that are linked through a communications network. In a distributed computing environment, program modules may be located in both local and remote memory storage devices.

In an embodiment of the invention, central processor unit 10 obtains a face image from digital camera 34. A user may view the face image on display device 42 and enter points (e.g., points 206-231 as shown in FIG. 2) to form a mesh that is subsequently altered by central processor 10 as discussed above. The user may identify the points with a pointer device (e.g. mouse 30) that is displayed on display device 42, which overlays the mesh over the face image. With embodiments of the invention, a face image may be stored and retrieved from hard disk drive 18 or removable memory drive 22 or obtained from an external server (not shown) through LAN 52 or WAN 54.

As can be appreciated by one skilled in the art, a computer system (e.g., computer 1 as shown in FIG. 9) with an associated computer-readable medium containing instructions for controlling the computer system may be utilized to implement the exemplary embodiments that are disclosed herein. The computer system may include at least one computer such as a microprocessor, a cluster of microprocessors, a mainframe, and networked workstations.

While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims.

We claim:

1. A method for altering a face image of a person, comprising:
(a) locating a plurality of points on a two-dimensional image of a face and a neck of the person;
(b) generating a mesh from the plurality of the points, the mesh being superimposed on the two-dimensional image and associated with corresponding texture of the two-dimensional image;
(c) reshaping the face by relocating a proper subset of points to obtain a desired degree of fattening or thinning of the face; and
(d) rendering a reshaped image from the two-dimensional image and a transformed mesh.

2. The method of claim 1, further comprising:
(e) reshaping the neck by relocating selected points from the plurality of points.

3. The method of claim 1, (c) comprising:
(c)(i) applying a deformation vector to one of the proper subset of points.

4. The method of claim 2, (e) comprising:
(e)(i) applying a deformation vector (\vec{v}_{d}) to one of the selected points.

5. The method of claim 3, (c) further comprising:
(c)(ii) determining the deformation vector from a product of factors, the product having a weight value factor (A), a scale factor (s), a deformation factor (w), and a direction vector (\vec{u}).

6. The method of claim 5, (c) further comprising:
(c)(iii) determining the weight value factor from a desired amount of fattening or thinning.

7. The method of claim 5, (c) further comprising:
(c)(iii) determining the scale factor, wherein the deformation vector is independent of a size of the head.

8. The claim of claim 5, (c) further comprising:
(c)(iii) differently calculating the deformation factor for different parts of cheeks and chin.

9. The method of claim 5, (c) further comprising:
(c)(iii) determining the direction vector from a difference between a center and said one of the proper subset of points.

10. The method of claim 1, wherein a vertex of the mesh corresponds to one of the plurality of points.

11. The method of claim 1, (a) comprising:
(a)(i) obtaining the plurality of points through an input interface.

12. The method of claim 1, (a) comprising:
(a)(i) obtaining the plurality of points from a trained process.

13. The method of claim 2, further comprising:
(f) determining the selected points for the neck from the proper subset of points.

14. The method of claim 5, further comprising:
(e) modifying the weight factor to alter the reshaped image.

15. A computer-readable medium having computer-executable instructions to perform the steps comprising:
(a) locating a plurality of points on a two-dimensional image of a face and a neck of the person;
(b) generating a mesh from the plurality of the points, the mesh being superimposed on the two-dimensional image and associated with corresponding texture of the two-dimensional image;
(c) reshaping the face by relocating a proper subset of points to obtain a desired degree of fattening or thinning of the face; and
(d) rendering a reshaped image from the two-dimensional image and a transformed mesh.

16. The computer medium of claim 15, having computer-executable instructions to perform the steps comprising:
(e) reshaping the neck by relocating selected points from the plurality of points.

17. The computer medium of claim 15, having computer-executable instructions to perform the steps comprising:
(c)(i) applying a deformation vector to one of the proper subset of points.

18. The computer medium of claim 15, having computer-executable instructions to perform the steps comprising:
(e)(i) applying a deformation vector to one of the selected points.

19. An apparatus for altering a face image of a person, comprising:
an input device configured to obtain a plurality of points on a two-dimensional image of a face and a neck of the person; and
a processor configured to:
generate a mesh from the plurality of the points, the mesh being superimposed on the two-dimensional image and associated with corresponding texture of the two-dimensional image;
reshape the face by relocating a proper subset of points to obtain a desired degree of fattening or thinning of the face; and
render a reshaped image from the two-dimensional image and a transformed mesh.

20. The apparatus of claim 19, the processor further configured to reshape the neck by relocating selected points from the plurality of points.

21. The apparatus of claim 19, further comprising:
a storage device, wherein the processor is configured to retrieved the two-dimensional image of the face and the neck of the person.
